(19) United States
(12) Patent Application Publication
(10) Pub. No.: US 2013/0177534 A1
(43) Pub. Date: Jul. 11, 2013

(54) PLANT PROTECTION AGENT COMPRISING INSECT-PATHOGENIC VIRUSES, IN PARTICULAR BACULOVIRUSES, AND CELLULOSE SULFATE

(71) Applicants: Peter Fischer, Effeltrich (DE); Eric Geppert, Nurnberg (DE); Matthias Fischbach, Goettingen (DE)

(72) Inventors: Peter Fischer, Effeltrich (DE); Eric Geppert, Nurnberg (DE); Matthias Fischbach, Goettingen (DE)

(21) Appl. No.: 13/818,217

(22) PCT Filed: Aug. 23, 2011
(86) PCT No.: PCT/EP11/64483

§ 371 Date: Mar. 19, 2013

(30) Foreign Application Priority Data
Aug. 24, 2010 (DE) 10 2010 037 141.6

(51) Int. Cl. A01N 63/00

(52) U.S. Cl. CPC A01N 63/00
USPC 424/93.6; 435/239

(57) ABSTRACT

The present invention relates to a crop protection agent containing insect-pathogenic viruses, in particular baculoviruses, and cellulose sulfate and/or derivatives thereof.

The present invention relates to a plant protection agent comprising insect-pathogenic viruses, in particular baculoviruses, and cellulose sulfate and/or its derivatives.

Insects annually cause an economical damage which may amount to 20 to 30% of the world harvest. The mass occurrence of harmful insects is observed in particular when growing monocultures. When pesticides are employed on a large scale, all of the insects of a biotope are affected by them, and the ecological balance is endangered. This is why viruses are increasingly being employed in pest control. Viruses are highly selective in respect of their hosts while leaving the beneficial populations unharmed. It has been estimated that approximately 30% of the main pests of agricultural crop plants worldwide may be controlled using baculoviruses. U.S. Pat. No. 6,042,843 has described the use of baculoviruses of the strain Plutella xylostella for controlling harmful insects.

In apple growing, in particular, baculoviruses have been employed for years as insect-pathogenic viruses. Baculoviruses are insect-pathogenic viruses which preferentially infect larvae. The advantages of the baculoviruses include their strict host specificity and the fact that they are degraded without leaving residues, which allows the treatment of fruits even shortly before they are harvested.

Furthermore, baculoviruses form occlusion bodies (OB), which permit the viruses to retain the biological activity over prolonged periods even outside the host. These active virus particles within a protective occlusion body ensure that the infection chain via the peroral infection of the insect larvae remains unbroken even when insect population densities fluctuate greatly.

In apple growing, the baculoviruses are employed against codling moth larvae. In recent years, however, virus-resistant codling moths have been detected (Asser-Kaiser, Science, 2007).

Therefore, plant protection products with an enhanced activity are required, and/or the activity of existing plant protection products must be enhanced.

Cellulose sulfate is based on cellulose, which is a polysaccharide of beta-D-glucose molecules, or cellobiose monomers. Cellulose, which is usually obtained from cotton or timber, is sulfated by means of a sulfating agent (usually concentrated sulfuric acid).

Cellulose sulfate is a biopolymer which has polyelectrolyte character and which is capable of forming complexes with oppositely charged ions. These complexes are referred to as coacervates. Complexes of cellulose sulfate with polycations can form microspheres which are used for encapsulating mammalian cells, insect cells and enzymes. They are also employed for culturing baculoviruses, as described, for example, in EP 1982758 A1. According to a WHO study, an anti-HIV activity was detected in a cellulose-sulfate-comprising preparation.

The use of cellulose sulfate in plant protection products as thickener has been described in DE 1130589 B, in WO 01/60159 A1 and in US 2007/0179058 A1. However, those are not plant protection products comprising insect-pathogenic viruses.

DD 299313, too, discloses the use of water-soluble sulfates of cellulose as thickeners and as components for the preparation of membranes and for microencapsulation. According to the teaching of DE 102005011367 B4 and DE 19756499 C2, sodium cellulose sulfate is employed for the preparation of microcapsules for immobilizing cells.

An object of the present invention is to provide novel, improved plant protection products. It is intended that these plant protection products demonstrate an increased activity so that, when used at markedly lower concentrations, they can achieve the same activity as traditional plant protection products.

This is intended to markedly reduce the consumption of chemical insecticides.

Another object of the present invention is in particular to reduce the costs for protecting plants and for controlling harmful insects.

This object is achieved by a plant protection product comprising insect-pathogenic viruses and cellulose sulfate.

According to the invention, the term “cellulose sulfate” also always comprises cellulose sulfate derivatives.

What is referred to as a derivative is a compound selected from the group consisting of:
salts of monovalent cations, for example Na+, K+, NH4+, divalent cations, for example Mg2+, Ca2+, Sr2+, Ba2+, Fe2+, and trivalent cations, for example Al3+, Fe3+;
cellulose sulfate with at least one alkoxy group per cellobiose monomer;
cellulose sulfate substituted by methyl-, ethyl-, acetyl- at one or more monomers of the cellulose sulfate molecule substituted by methyl-, ethyl-, acetyl
degree of sulfatation, or degree of substitution, of from 0.01 to 3.0, in particular of from 0.4 to 0.7, preferably 0.5 to 0.6, in particular 0.6;
in particular water-soluble cellulose sulfates.

In one variant of the present invention, the plant protection product according to the invention comprises cellulose sulfate derivatives substituted by methyl-, ethyl-, acetyl- at one or more monomers of the cellulose sulfate molecule.

In a further variant of the present invention, the cellulose sulfate is present in water-soluble form.

In another embodiment of the present invention, the cellulose sulfate is present in bound form as a coacervate to a polycation.

One embodiment of the present invention is characterized in that the insect-pathogenic viruses are baculoviruses, preferably granuloviruses and/or nuclear polyhedrosis viruses.

In one alternative of the plant protection product according to the invention, the plant protection product is a product for controlling insects, in particular from the genus Lepidoptera.

In one such alternative, the plant protection product according to the invention is an insecticide.

According to the invention, the plant protection product may be employed as a spray liquor.

In one embodiment of the present invention, the plant protection product comprises insect-pathogenic viruses, preferably baculoviruses, at a concentration of from 1×10⁵ to 1×10¹⁵/g, and cellulose sulfate in a content of from 0.01% to 70%, in particular from 0.1 to 10%.

In a further embodiment of the present invention, the plant protection product comprises insect-pathogenic viruses, preferably baculoviruses, at a concentration of from 1×10⁵ to 1×10¹⁵/kg, and cellulose sulfate at a concentration of from 0.1 ppm to 700 ppm.

One embodiment of the present invention is characterized in that the insect-pathogenic viruses, preferably baculoviruses, are cultured in immobilized insect cells and subsequently isolated therefrom.

Further subject matter of the present invention is a method for the preparation of the plant protection product according to the invention, in which the insect-pathogenic viruses, preferably baculoviruses, are cultured in immobilized insect cells and subsequently isolated therefrom.

In one alternative of the method according to the invention, the insect-pathogenic viruses, preferably baculoviruses, are cultured in cellulose-sulfate-encapsulated insect cells and subsequently isolated therefrom.

In one embodiment, the plant protection product according to the invention is prepared by encapsulating insect cells in cellulose sulfate, preferably sodium cellulose sulfate, culturing them and subsequently infecting them with baculoviruses, or the infected insect cells are encapsulated in cellulose sulfate, preferably sodium cellulose sulfate, and cultured.

Thereafter, the immobilisates which comprise the infected insect cells are isolated, and the isolated immobilisates are freeze-dried and ground. If appropriate, the immobilisates are homogenized before freeze-drying.

In this embodiment, the product according to the invention is present as a pulverulent formulation.

In one alternative, pulverulent fillers, such as powdered milk, sucrose, yeast extract, peptone, lignins, are added to the pulverulent formulation.

In another embodiment of the method according to the invention, the immobilisates are homogenized after their isolation, and the product is present in liquid form.

In a further embodiment, it is essential to the preparation of the plant protection product according to the invention that no purification of the viruses from the immobilisates takes place.

A further subject matter of the present invention is the use of the plant protection product according to the invention for controlling insects, in particular from the genus Lepidoptera.

In one variant of the present invention, cellulose sulfate and plant protection products comprising insect-pathogenic viruses are applied together, simultaneously and/or in a mixture.

In a further embodiment of the present invention, cellulose sulfate is applied after the application of the plant protection product according to the invention, comprising insect-pathogenic virses.

In a further embodiment of the present invention, cellulose sulfate is applied before the application of the plant protection product according to the invention, comprising insect-pathogenic viruses.

Both the cellulose sulfate and the plant protection product comprising insect-pathogenic viruses demonstrate high stability and retain their respective activity over weeks, preferably months.

Accordingly, cellulose sulfate and the plant protection product according to the invention comprising insect-pathogenic viruses are—irrespective of the order—applied within a period of two months, preferably six weeks, five weeks, four weeks, especially preferably three weeks, two weeks, one week, in particular six days, five days, four days, three days, one day.

According to the invention, an enhancement of the activity is always determined in comparison with a control, where the plant protection product is applied under identical conditions and in identical concentrations, but without coming into contact with cellulose sulfate.

According to the invention, the enhancement of the activity of the plant protection product is determined in comparison with a control. The control comprises applying the plant protection product under identical conditions as in the method according to the invention. However, neither before nor after applying the control plant protection product, nor simultaneously therewith, is cellulose sulfate applied to plants. The activity can be determined with reference to the damage, for example the damaged plants, leaves, seeds or fruits, or, in another embodiment, by means of the yield of the agricultural product, such as, for example, seeds or fruits.

An enhancement of the activity means, in accordance with the invention, that it is possible to employ a lower concentration of plant protection product for achieving the same effect as the control. In the method according to the invention, the concentration of the plant protection product may be reduced to 80%, 70%, 60%, 50%, 40%, 30%, 20%, preferably 10%, 5%, 1%, 0.5%, 0.25%, 0.1%, 0.005%, especially preferably 0.001% in comparison with the viruses employed for control purposes.

The enhancement, according to the invention, of the activity of the plant protection product comprising insect-pathogenic viruses by cellulose sulfate is characterized in that the active content of the insect-pathogenic viruses can be reduced by one or more orders of magnitude while retaining the same high efficacy.

In an alternative of the present invention, therefore, the concentration of insect-pathogenic viruses can be reduced to 10%, 1%, preferably 0.5%, 0.1%, especially preferably 0.05%, 0.01%, in particular 0.005%, 0.001%, of the concentration in comparison with the control.

For the purposes of the present invention, the expression “applying the plant protection product to plants” is to be understood as meaning that the plant protection product is applied directly to the plants to be protected or to parts of plants, such as, for example, leaves, seeds or fruits, or to the locus of the plant to be protected, and also directly to the harmful insects which are on the plant, at the plant or at the locus thereof.

An alternative of the present invention relates, in addition to the use of the virus-comprising plant protection product, to the use and the employing of at least one further plant protection product, preferably selected from the group of insecticides, fungicides and herbicides, in particular insecticides.

In one embodiment, cellulose sulfate or a mixture of the virus-comprising plant protection products with cellulose sulfate is applied in addition to the abovementioned plant protection products.

A further embodiment of the present invention relates to the employing of cellulose sulfate at a concentration of from 0.1 ppm to 10 000 ppm, preferably 1 ppm to 5000 ppm, especially preferably 1 ppm to 1000 ppm, particularly preferably 1 ppm to 5000 ppm.

One embodiment of the present invention relates to the use of cellulose sulfate in water-soluble form or as a coacervate to a polycation in bound form.

The cellulose sulfate may be present as a component of the plant protection product.

In one alternative of the method according to the invention, the cellulose sulfate is added to the spray liquor when applying the plant protection product.

In one variant of the present invention, the insect-pathogenic viruses of the plant protection product are baculoviruses.

In a further embodiment of the method according to the invention, they are viruses, preferably baculoviruses, in which the insecticidal potential has been optimized by means of recombinant methods. Thus, for example, the host range has been widened specifically, or the baculoviruses' virulence toward older larval stages has been enhanced, or their rate of activity has been increased, by means of recombinant methods. The recombinant methods include, for example, the integration of neurotoxin genes into the viral genome or the deletion of the viral egt gene. A significant enhancement of the rate of activity can thereby be achieved. Insect-specific neurotoxins can be isolated for example from scorpions or mites and expressed in recombinant viruses. A list in recombinant viruses which can be used in accordance with the invention (and which is hereby included by reference) is disclosed in Chen, X. W. et al. (Journal of Invertebrate Pathology, 76, 140-146).

In a further embodiment of the method according to the invention, enhancin is applied together with cellulose sulfate and/or the insect-pathogenic viruses.

Enhancin is a protein formed by the Trichoplusia ni granulovirus and which enhances infections, preferably those caused by viruses in various genera of Lepidoptera.

The enhancement of the efficacy can also be achieved by separately adding enhancin in purified form or by integrating the enhancin-encoding gene into the insect-pathogenic virus and/or by adding Trichoplusia ni (Hübner) granulovirus.

Enhancin affects the integrity of the gut membrane in the larval mesenteron and results in an enhanced activity in various viral species, for example T. ni, Helicoverpa zea (Boddie), Heliothis virescens (Fabricius), Spodoptera exigua (Hübner), Pseudoplusia includens (Walker), and Anticarsia gemmatalis (Hübner) (Granados et al.; Biological Control 20, 153-159 (2001)).

In one variant of the present invention, the viruses and the cellulose sulfate are jointly present in lyophilized form. This ensures a good dispersibility and therefore easy preparation of the spray liquor. In addition, it also ensures a long shelf-life and stability both of the viruses and of the cellulose sulfate.

In one alternative of the present invention, such a mixture of insect-pathogenic viruses and cellulose sulfate is applied at a concentration of 0.01 g, 10 g/acre. 1 acre corresponds to an area of 4046.856 m², or approximately 0.4 ha. It is preferred to apply from 0.1 to 10 g, in particular from 0.2 to 5 g, especially preferably 0.4 g/acre. The mixture of plant protection product and cellulose sulfate comprises from 0.01 to 10 occlusion bodies (OB)/g, preferably from 0.05 to 1 OB/g, especially preferably from 0.01 to 0.03 OB/g.

To fully protect the plants for one season, from 0.1 to 100 g/acre, preferably from 0.5 to 10 g/acre, especially preferably from 1 to 2 g/acre, in particular 1.2 g/acre, of the above-described mixture are applied in accordance with the invention.

In one alternative of the present invention, to fully protect the plants, from 0.1 to 10×10¹² occlusion bodies/acre, preferably from 0.5 to 5×10¹² occlusion bodies, especially preferably from 1 to 2×10¹² occlusion bodies, in particular 1.2×10¹² occlusion bodies/acre are applied per season.

In a further alternative of the present invention, the abovementioned amounts of plant protection product together with cellulose sulfate are applied in three individual applications. Preferably, the applications are carried out at an interval of from one to three weeks, in particular at an interval of in each case two weeks.

In one embodiment, the method according to the invention is employed for protecting fruit and vegetable plants, in particular fruit trees, especially preferably apple trees, and/or the corresponding fruits.

The plant protection products according to the invention can be employed for example in fruit production, in particular for protecting apples, pears, quinces, apricots, peaches, plums, cherries, hawthorn, sweet chestnuts and walnut, against pests, especially against insects, in particular against their larvae.

In one variant of the present invention, one or more viruses selected from the group comprising Cydia pomonella granuloviruses (CpGV), Cydia pomonella GV mexican strain, Autographa californica AcMNPV, Helicoverpa armigera MNPV, Choristoneura furniferana NPV, Spodoptera litoralis, MNPV, Lobesia botrana GV, Thaumetopoea processionea NPV, Helicoverpa zea (Heliothis zea), (HzSNPV), Tuta absoluta NPV, Plutella xylostella (PxMNPV), Spodoptera exigua (SeMNPV), Spodoptera frugiperda (SfMNPV) and Lymantria dispar LdNPV are employed.

Details on the viruses can be found in Table A hereinbelow:

TABLE A

| Virus | Pest | Plant |
|---|---|---|
| Cydia pomonella GV | Codling moth | Apple |
| Autographa | Alfalfa looper | Cotton, soybeans, |
| californica AcMNPV | | vegetables |
| Helicoverpa armigera | Cotton bollworm | Cotton, maize, |
| MNPV | | tobacco, tomato . . . |
| Choristoneura | Spruce budworm | Forest, fir, spruce |
| furniferana NPV | | |
| Spodoptera litoralis | Egyptian cotton | Cotton, cabbage |
| MNPV | leafworm | |
| Lobesia botrana GV | Grape berry moth | Grapevines |
| Thaumetopoea | Oak processionary | Oaks (dangerous for |
| processionea NPV | moth | humans) |
| Helicoverpa zea | Cotton bollworm, tomato | Maize, cotton, |
| (Heliothis zea) | fruitworm, sorghum | soybeans |
| (HzSNPV) | headworm | |
| Tuta absoluta NPV | Tomato leaf miner | Tomato |
| Plutella xylostella | Diamondback moth | Vegetables, |
| (PxMNPV) | | cabbage |
| Spodoptera exigua | Beet armyworm | Vegetables, |
| (SeMNPV) | | cabbage |
| Spodoptera frugiperda | Fall armyworm | Cotton, soybeans |
| (SfMNPV) | | |
| Lymantria dispar | Gypsy moth | Deciduous forest |
| LdNPV | | |

By using cellulose sulfate, the plant protection products according to the invention demonstrate synergetic effects. Synergetic effects means, according to the invention, better control of the pests than would have been expected when employing the plant protection products or cellulose sulfate individually.

In one embodiment of the present invention, cellulose sulfate and the plant protection product comprising insect-pathogenic viruses are taken up by the harmful insect by feeding and are present incorporated at the same time in vivo in the harmful insect so as to display their activity.

### EXAMPLES

The examples demonstrate an increased activity of the plant protection product according to the invention with an activity of 94-100% (Tables 1 and 2). This result was obtained using a considerably lower active substance concentration in comparison with other available products (Table 3).

TABLE 1
Biological efficacy of the plant protection product according to the invention
comprising insect-pathogenic viruses: CpGV together with sodium cellulose
sulfate against Cydia pomonella L. in early apple varieties

| | | | | | Reduction | | |
|---|---|---|---|---|---|---|---|
| | | | Mean | | in damage | | |
| | | | number | | relative | | |
| | | | of | | to the | | |
| | Usual rate of | | damaged | | control | | Biological |
| | application | | fruits | | (%) | | harvest of |
| | (1 × 10 * 12 | | Wind- | Picked | Wind- | Picked | the fruits, |
| Variant | granules/g) | | falls | fruit | falls | fruit | kg/tree |
| Plant | 1.0 g | 1 | 46 | 0 | 94.2 | 100 | 162 |
| protection | | 2 | 44 | 0 | 94.4 | 100 | 157 |
| product | | mean: | 45 | 0 | 94.3 | 100 | 159.5 |
| comprising | | | | | | | |
| insect- | | | | | | | |
| pathogenic | | | | | | | |
| viruses: CpGV | | | | | | | |
| together with | | | | | | | |
| sodium | | | | | | | |
| cellulose | | | | | | | |
| sulfate | | | | | | | |
| Control | | 1 | 760 | 210 | | | 72 |
| | | 2 | 830 | 226 | | | 88 |
| | | mean: | 795 | 218 | | | 80 |

TABLE 2
Biological efficacy of the plant protection product according to the invention
comprising insect-pathogenic viruses: CpGV together with sodium cellulose
sulfate against Cydia pomonella L. in late apple varieties

| | | | Mean | | Reduction | |
|---|---|---|---|---|---|---|
| | | | number of | | in damage | |
| | Usual rate of | | damaged | | relative to | |
| | application | | fruits | | the control (%) | |
| Variant | (1 × 10 * 12 granules/g) | | Windfalls | Picked fruit | Windfalls | Picked fruit |
| Plant | 1.0 | 1 | 105 | 21 | 94.2 | 100 |
| protection | | 2 | 114 | 19 | 94.4 | 100 |
| product | | mean: | 109.5 | 20 | 94.3 | 100 |
| comprising | | | | | | |
| insect- | | | | | | |
| pathogenic | | | | | | |
| viruses: CpGV | | | | | | |
| together with | | | | | | |
| sodium | | | | | | |
| cellulose | | | | | | |
| sulfate | | | | | | |
| Control | | 1 | 1.010 | 184 | | |
| | | 2 | 940 | 159 | | |
| | | mean: | 975 | 171.5 | | |

Granules = OB (occlusion bodies)

TABLE 3
Comparison of the dosage recommendations for commercially
available, comparable products (USA)

| | Product | | | |
|---|---|---|---|---|
| | | | | Plant protection product |
| | | | | comprising insect-pathogenic |
| | | | | viruses: CpGV together |
| | Product 1 | Product 2 | Product 3 | with cellulose sulfate |
| Occlusion bodies | ≧3 | ≧0.9 | 4 | 0.1-0.3 (per g) |
| (OB) per liter | | | | |
| (×1013) | | | | |
| OB | 0.06% | 0.99% | 0.07% | N/A |
| concentration | | | | |
| (%) | | | | |
| How supplied | liquid | frozen | frozen | lyophilized powder |
| | | | suspension | |
| Storage | chilled | chilled or | chilled or | chilled at 4° C. |
| | | frozen | frozen | |
| Application rate | 0.18 l/acre | 0.4 l/acre | 0.1 l/acre | 0.4 g/acre |
| | 5.3 × 10¹² | 3.6 × 10¹² | 4.0 × 10¹² | 0.4 × 10¹² |
| | OB/acre | OB/acre | OB/acre | OB/acre |
| Total application | 0.54 l/acre | 1.2 l/acre | 0.3 l/acre | 1.2 g/acre |
| (3×) | | | | |
| Total application | 15.9 | 11.8 | 12.0 | 1.2 |
| (3×) | | | | |
| OB/acre (×10¹²) | | | | |
| Price | $307-$393/l | $130/l | $350/l | 20-30 [symbol] /g |
| | (on average | | | (wholesale price) |
| | $350/l) | | | |

1.-15. (canceled)

16. A plant protection agent, wherein the agent comprises insect-pathogenic viruses and cellulose sulfate.

17. The agent of claim 16, wherein the agent comprises cellulose sulfate wherein one or more monomer units of the cellulose sulfate molecule are substituted by one or more of a methyl, an ethyl, or an acetyl group.

18. The agent of claim 16, wherein the insect-pathogenic viruses comprise baculoviruses.

19. The agent of claim 18, wherein the insect-pathogenic viruses comprise at least one of granuloviruses and nuclear polyhedrosis viruses.

20. The agent of claim 16, wherein the cellulose sulfate is present in water-soluble form.

21. The agent of claim 16, wherein the cellulose sulfate is present in bound form as a coacervate to a polycation.

22. The agent of claim 16, wherein the agent is capable of controlling insects.

23. The agent of claim 22, wherein the insects comprise insects from the genus Lepidoptera.

24. The agent of claim 16, wherein the agent is present as a spray liquor.

25. The agent of claim 16, wherein the insect-pathogenic viruses are present at a concentration of from 1×10⁵ to 1×10¹⁵/g, and cellulose sulfate is present at a concentration of from 0.01% to 70%.

26. The agent of claim 25, wherein cellulose sulfate is present at a concentration of from 0.1% to 10%.

27. The agent of claim 16, wherein the insect-pathogenic viruses are present at a concentration of from 1×10⁵ to 1×10¹⁵/kg, and cellulose sulfate is present at a concentration of from 0.1 ppm to 700 ppm.

28. The agent of claim 16, wherein the insect-pathogenic viruses were cultured in immobilized insect cells and subsequently isolates therefrom.

29. A method for the preparation of the plant protection agent of claim 16, wherein the method comprises culturing the insect-pathogenic viruses in immobilized insect cells and subsequently isolating the viruses therefrom.

30. A method for the preparation of the plant protection agent of claim 16, wherein the method comprises culturing the insect-pathogenic viruses in cellulose-sulfate-encapsulated insect cells and subsequently isolating them therefrom.

31. A method for the preparation of the plant protection product of claim 16, wherein the method comprises:
(a) encapsulating insect cells in cellulose sulfate and culturing and subsequently infecting them with insect-pathogenic viruses, or
(b) encapsulating infected insect cells in cellulose sulfate and culturing them,
(c) isolating immobilisates which comprise infected insect cells,
(d) freeze-drying and grinding the optionally homogenized isolated immobilisates of (c),
(e) providing the product of (d) as a pulverulent formulation,
(f) adding pulverulent filler to the pulverulent formulation of (e), or
(g) homogenizing the immobilisates of (c) and providing a corresponding product in liquid form.

32. The method of claim 31, wherein the pulverulent filler comprises one or more of milk powder, sucrose, yeast extract, and peptone lignins.

33. A method of controlling insects which infest plants, wherein the method comprises applying the plant protection agent of claim 16.

34. The method of claim 33, wherein the insects comprise insects of the genus Lepidoptera.

35. The method of claim 33, wherein from 0.1 to 10×10¹² occlusion bodies/acre are applied.
